(19) United States
(12) Patent Application Publication
(10) Pub. No.: US 2014/0032447 A1
(43) Pub. Date: Jan. 30, 2014

(54) Displays and Methods for Selling Elongated Sporting Boards

(71) Applicant: Geoff Fisher, San Marcos, CA (US)

(72) Inventor: Geoff Fisher, San Marcos, CA (US)

(21) Appl. No.: 13/952,482

(22) Filed: Jul. 26, 2013

Related U.S. Application Data
(60) Provisional application No. 61/676,210, filed on Jul. 26, 2012.

(51) Int. Cl. A47F 7/00; G06Q 90/00

(52) U.S. Cl. CPC A47F 7/0021; G06Q 90/00
USPC 705/500; 211/85.7

(57) ABSTRACT

Described herein are apparatuses, systems and methods for displaying and selling elongated sporting boards.

### CROSS REFERENCE TO RELATED APPLICATIONS

This application claims the benefit of U.S. Provisional Patent Application Ser. No. 61/676,210, filed Jul. 26, 2012, the entire disclosure of which is incorporated herein by reference.

### BACKGROUND

Generally, selling goods without the aid of onsite staff possessing particular knowledge of the goods can be challenging. Further, for large odd shaped goods, the task can be even more challenging as costs associated with transport, storage and retail floor space can be issues.

As such, in many retail areas, again where local knowledge of the good may be lacking, there is a need for display methods that can aid in the retail appeal, sellability, space conservation, transport and/or staging of a good. Described below are apparatuses and methods that can accomplish these tasks.

### SUMMARY

Described herein generally are elongated sporting board rack systems. Elongated sporting boards as described herein can include, for example, but are not limited to, surfboards and paddle boards. These systems can comprise a spine including at least a first vertical support structure and a second vertical support structure each configured to vertically support at least one elongated sporting board at a presentation angle. In some embodiments, the spine can include at least a first support bar configured to mount the first vertical support structure and a second support bar configured to mount the second vertical support structure.

Each vertical support structure can include a bottom support configured to support the bottom of an elongated sporting board, a first side support configured to support a first side of the elongated sporting board, and a second side support configured to support a second side of the elongated sporting board.

Methods of selling elongated sporting boards in a retail location using the above described elongated sporting board rack systems are also described. These methods can comprise displaying to a buyer the elongated sporting board on a self selling display apparatus comprising a spine including at least a first vertical support structure and a second vertical support structure each configured to vertically support at least one elongated sporting boards at a presentation angle; and selling the at least one elongated sporting board to the buyer with minimal or less than minimal input from the self service retailer.

Retail locations can include sporting goods stores in general as well as any store that may want to sell elongated sporting boards. Self service retailers may also use the present apparatus and systems to aid in selling product. Self service retailers can include warehouse locations, general purpose stores, military post exchanges, or any location where little to no help is provided to a buyer/customer regarding a particular product or products. In such locations, the buyer can be educated about a product by the product itself, the display of the product. The display of the product can include an information pamphlet with information about the displayed product.

In other embodiments, elongated sporting board rack systems are described comprising: a cross bar configured to mount on at least two vertical tracks; a first arm covered in a protective material; and a second arm covered in a protective material. With such systems, the first arm and the second arm can be configured to mount on the cross bar and to vertically support an elongated sporting board at a presentation angle. Each arm can be mounted perpendicular to the cross bar or at an angle of about 45 degrees relative to the cross bar.

Such an elongated sporting board rack system can further comprise a second cross bar configured to mount lower than the first cross bar; a third arm covered in a protective material; and a forth arm covered in a protective material. In such an embodiment, the third arm and the forth arm are configured to mount on the second cross bar at a location offset from the first arm and the second arm thereby allowing the elongated sporting board to rest at an angle of at least 45 degrees relative to the ground.

In some embodiments, the at least two vertical tracks can have locations determined by a retail store. The width of a display can also be determined by the retail store and can be about 4 ft wide.

Methods of selling elongated sporting boards in a self service retailer using the above described elongated sporting board rack systems are also described. Such methods can comprise displaying to a buyer the elongated sporting board on a self selling display apparatus and selling the at least one elongated sporting board to the buyer with minimal or less than minimal input from the self service retailer. The apparatus can comprise a cross bar configured to mount on at least two vertical tracks; first arm covered in a protective material; and a second arm covered in a protective material are described. In some embodiments, the first arm and the second arm are configured to mount on the cross bar and to vertically support an elongated sporting board at a presentation angle.

### BRIEF DESCRIPTION OF THE DRAWINGS

FIGS. 1A-G illustrate an example elongated sporting board vertical display apparatus. FIG. 1A is a perspective view including an elongated sporting board; FIG. 1B is a perspective view including six bays; FIG. 1C is a front view; FIG. 1D is a back view; FIG. 1E is a first side view; FIG. 1F is a second side view; and FIG. 1G is a top view.

FIG. 2 illustrates exemplary features of an elongated sporting board vertical display apparatus.

FIG. 3 illustrates a perspective magnified view of a bottom support.

FIG. 4 illustrates a top magnified view of the bottom support.

FIGS. 5A-B illustrate an elongated sporting board vertical display showcased in a retail store display area. FIG. 5A is an empty vertical display apparatus. FIG. 5B is a vertical display apparatus including six elongated sporting boards.

FIGS. 6A-B illustrate an elongated sporting board vertical display system. FIG. 6A illustrates an empty system with perpendicular arms; and FIG. 6B illustrates the system with six elongated sporting boards.

FIGS. 7A-E illustrate an example arm for use in an elongated sporting board vertical display system. FIG. 7A is a top view; FIG. 7B is a side view; FIG. 7C is a bottom view; FIG. 7D is a front view; and FIG. 7E is a rear perspective view.

FIGS. 8A-C illustrate an elongated sporting board vertical display system with variable angled arms. FIG. 8A is a top view of arm/cross bar interface with the arm perpendicular to the cross bar; FIG. 8B is a top view of arm/cross bar interface with the arm angled relative to the cross bar; and FIG. 8C is a perspective view of a elongated sporting board vertical display system with angled arms and six elongated sporting boards.

FIGS. 9A-E illustrate another arm for use in an elongated sporting board vertical display system. FIG. 9A is a top view; FIG. 9B is a side view; FIG. 9C is a bottom view; FIG. 9D is a front view; and FIG. 9E is a rear perspective view.

FIG. 10 is a top view of arm/cross bar interface with the arm from FIGS. 9A-E perpendicular to the cross bar.

FIG. 11 illustrates another elongated sporting board vertical display system wherein longer boards can be angled to reduce height.

### DETAILED DESCRIPTION

Described are apparatuses for displaying, selling, transporting, storing, and/or mounting at least one elongated sporting board. Methods of using the apparatus for the above purposes are also described.

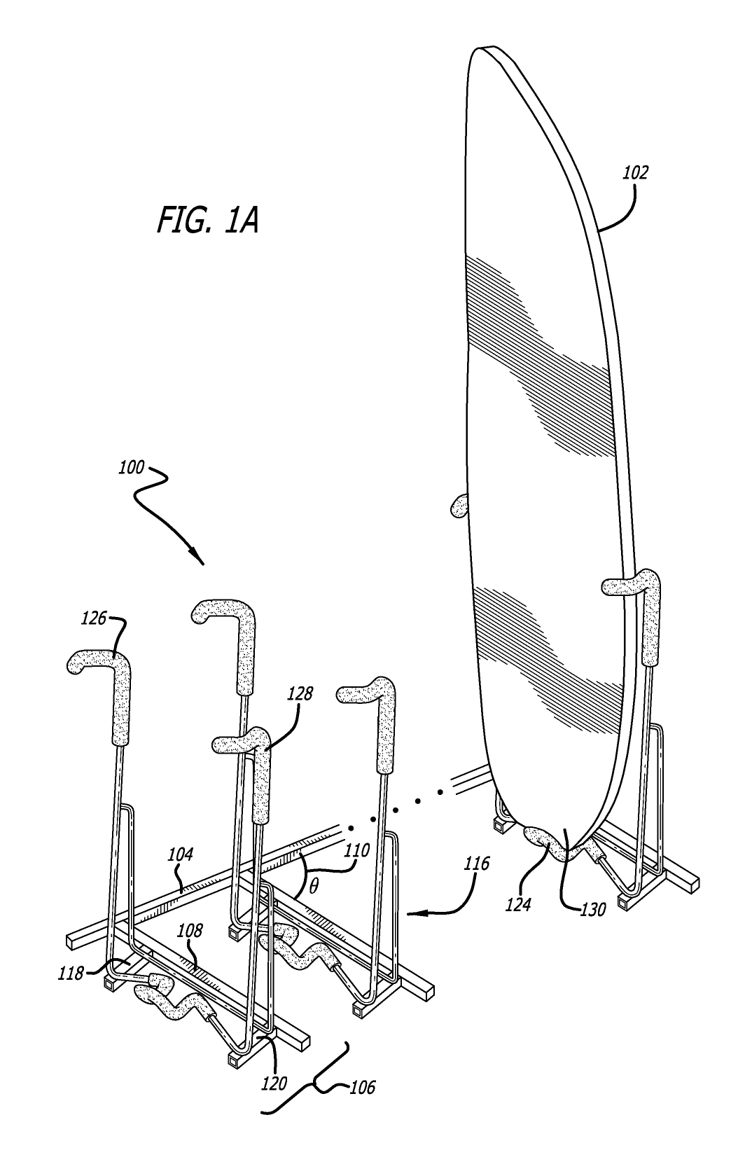

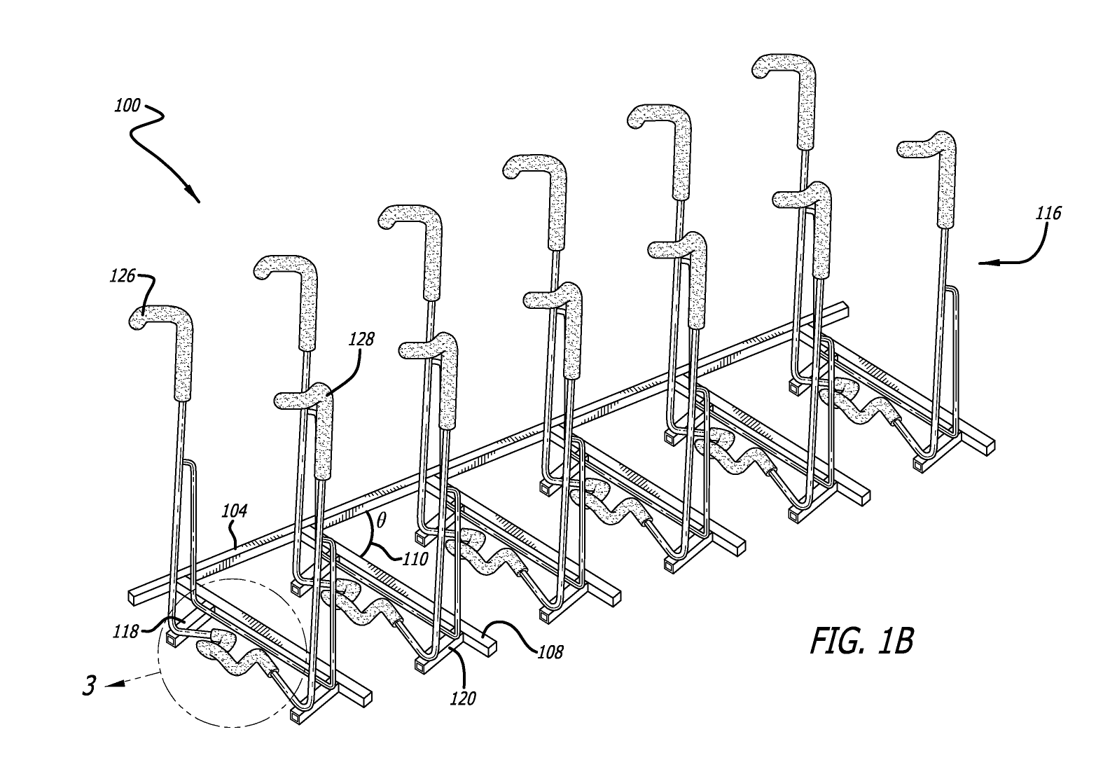

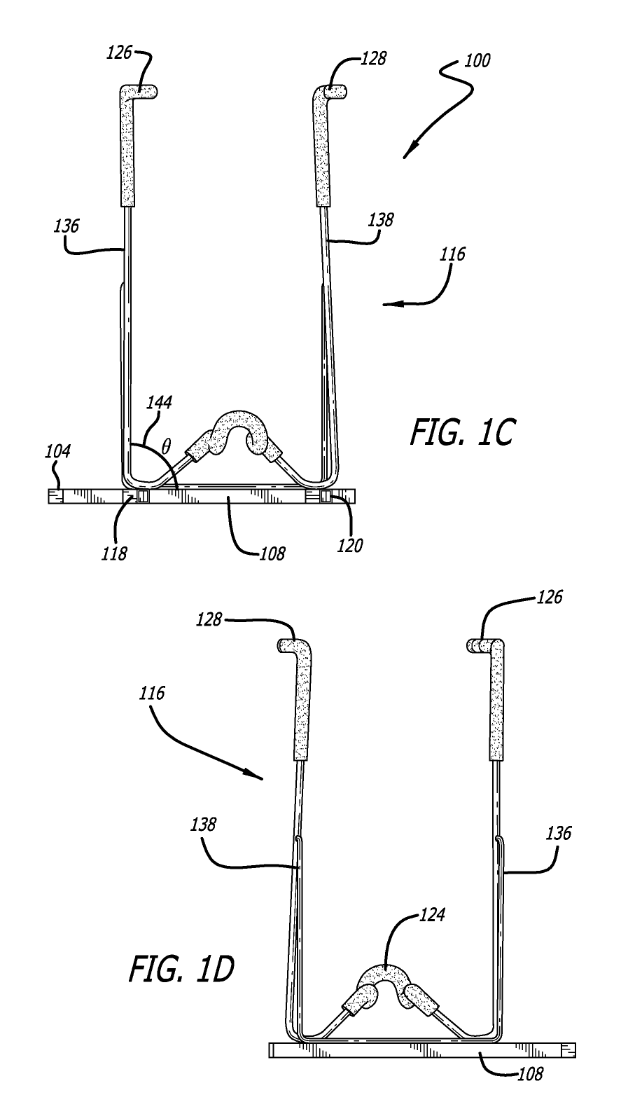

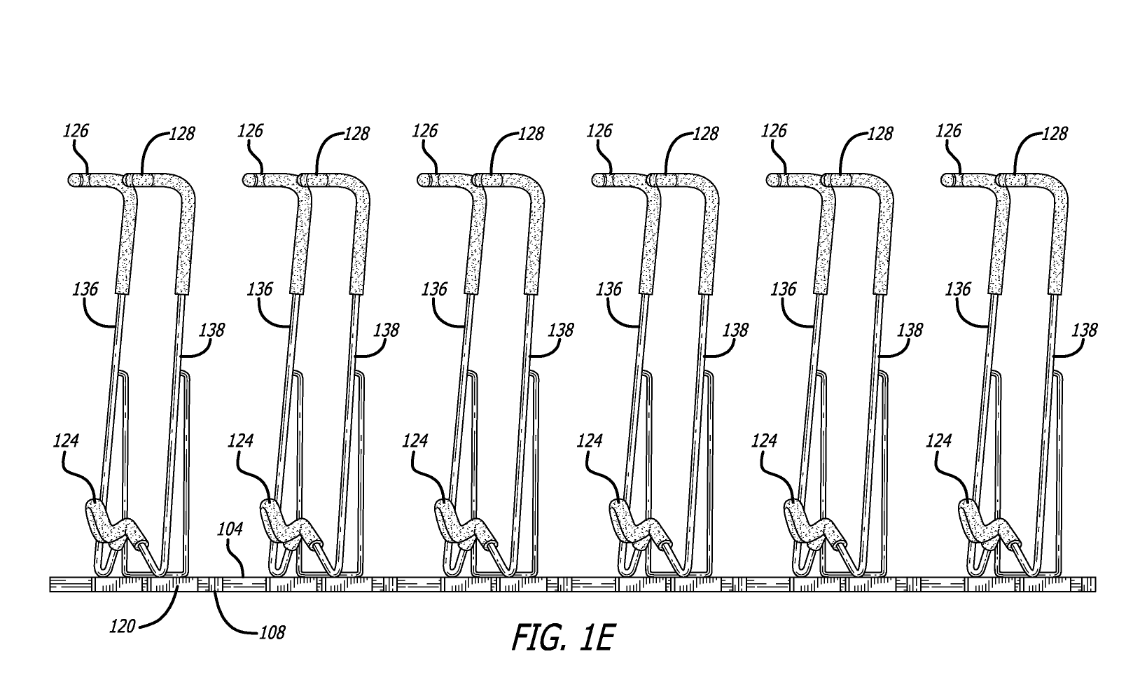

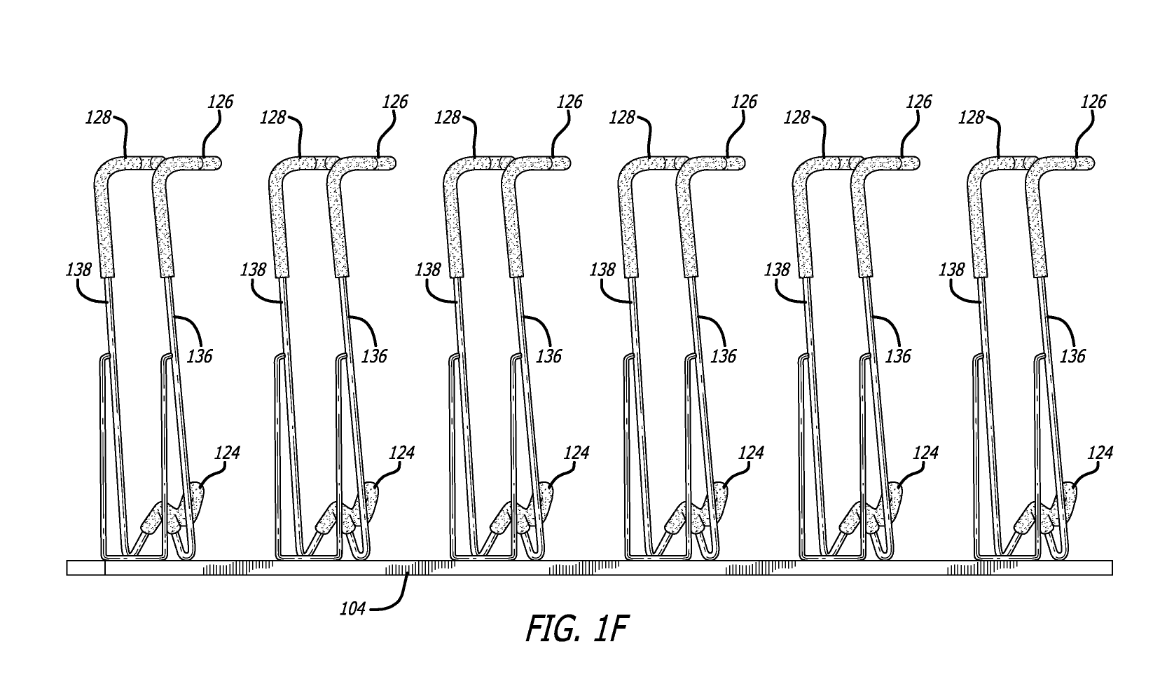

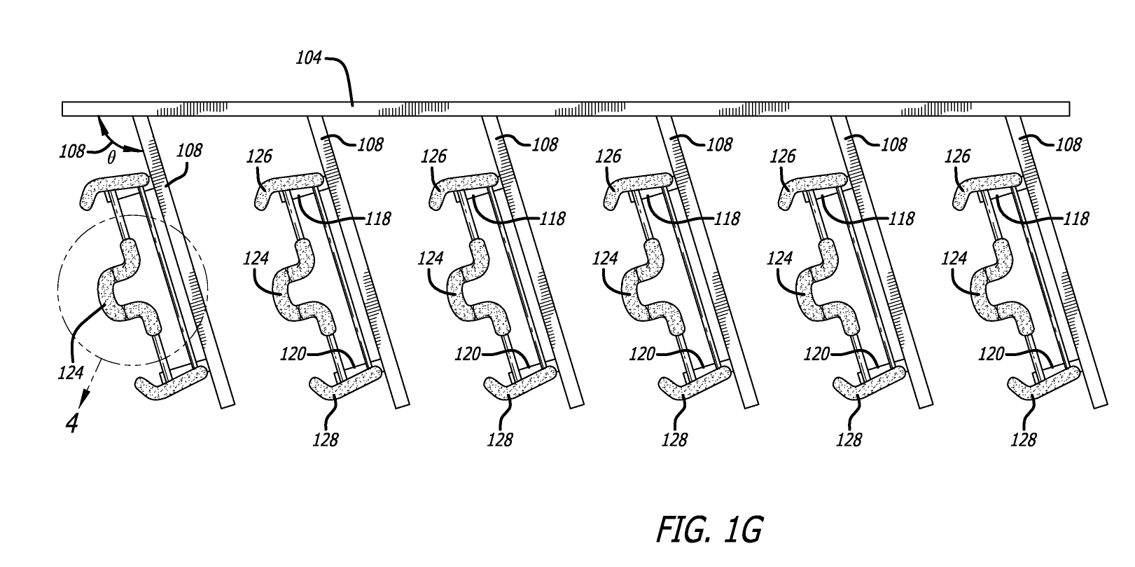

Generally, apparatus 100 in FIGS. 1A-G can at least aid in the displaying, selling, transporting, storing, and/or mounting of at least one elongated sporting board 102. Elongated sporting board 102 can be any piece of sporting equipment that is longer than about 3 ft, about 4 ft, about 5, ft, about 6 ft, about 7 ft, about 8 ft, 9 ft, 10 ft, 11 ft, 12 ft, 13 ft, 14 ft, 15 ft, or longer. Such equipment can include, but is not limited to surfboards, paddle boards, boogie boards, wake boards, knee boards, skim boards, water skies, kayaks, crew boats, snowboards, snow skies, skateboards, roller boards, sleds, toboggans, and the like.

In one embodiment, elongated sporting board 102 can include any piece of sporting equipment that resembles the general shape of a board. Such equipment can include, but is not limited to surfboards, paddle boards, boogie boards, wake boards, knee boards, skim boards, snowboards, skateboards, roller boards, sleds, and the like.

Apparatus 100 can include spine 104 which can be an elongated piece of framing material. Spine 104 can be configured to hold a plurality of elongated sporting boards. In aspects of this embodiment, spine 104 can be configured to hold one, two, three, four, five, six, seven, eight, nine, ten, eleven, twelve, thirteen, 14, 15, 16, 17, 18, 19, 20, at least one, at least two, at least three, at least four, at least five, at least six at least seven, at least eight, or at least nine elongated sporting boards.

Spine 104 can be formed of any material that can withstand the desired weight capacities of a given number of elongated sporting boards and accompanying parts of apparatus 100. Materials can include, but are not limited to aluminum, copper, brass, nickel, titanium, iron, steel, stainless steel, carbon fiber, plastic, fiberglass, other composite materials, or a combination thereof. The metal or plastic can be solid or hollow, circular, quadrilateral, or square in cross-section, and/or coated or uncoated. Further, spine 104 can include portions that are covered with a foam-like material or a soft polymeric material that protects equipment being displayed. In some embodiments, spine 104 can be formed of hollow metal or plastic to reduce overall weight of spine 104.

Spine 104 can have an adjustable length. In other embodiments, the length can be fixed. If adjustable, spine 104 can have two, three, four, five, six, seven, eight, nine, ten, eleven, twelve, at least two, at least three, at least four, at least five, at least six, at least seven, at least eight, at least nine, at least ten, at least eleven, or at least twelve different adjustable positions. Lengths of spine 104 can include about 1 ft, about 2 ft, about 3 ft, about 4 ft, about 5 ft, about 6 ft, about 7 ft, about 8 ft, about 9 ft, about 10 ft, about 11 ft, about 12 ft, between about 1 ft and about 3 ft, between about 2 ft and about 3 ft, between about 2 ft and about 5 ft, between about 1 ft and about 5 ft, between about 1 ft and about 12 ft, between about 1 ft and about 10 ft, or between about 3 ft and about 6 ft. Different length positions can be adjusted, for example, by using a spring pin and hole combination. Other methods and systems for length adjustment can be used.

Apparatus 100 can support about 10 lbs, about 20 lbs, about 30 lbs, about 40 lbs, about 50 lbs, about 60 lbs, about 70 lbs, about 80 lbs, about 90 lbs, about 100 lbs, about 150 lbs, about 200 lbs, about 250 lbs, about 300 lbs, about 350 lbs, about 400 lbs, about 450 lbs, about 500 lbs, about 550 lbs, about 600 lbs, about 650 lbs, about 700 lbs, about 750 lbs, about 800 lbs, about 850 lbs, about 900 lbs, about 1,000 lbs, about 1,100 lbs, about 1,200 lbs, about 1,300 lbs, about 1,400 lbs, about 1,500 lbs, between about 10 lbs and about 1,500 lbs, between about 100 lbs and about 1,000 lbs, between about 50 lbs and about 500 lbs, between about 10 lbs and about 500 lbs, between about 10 lbs and about 250 lbs, or between about 100 lbs and about 1,500 lbs of weight.

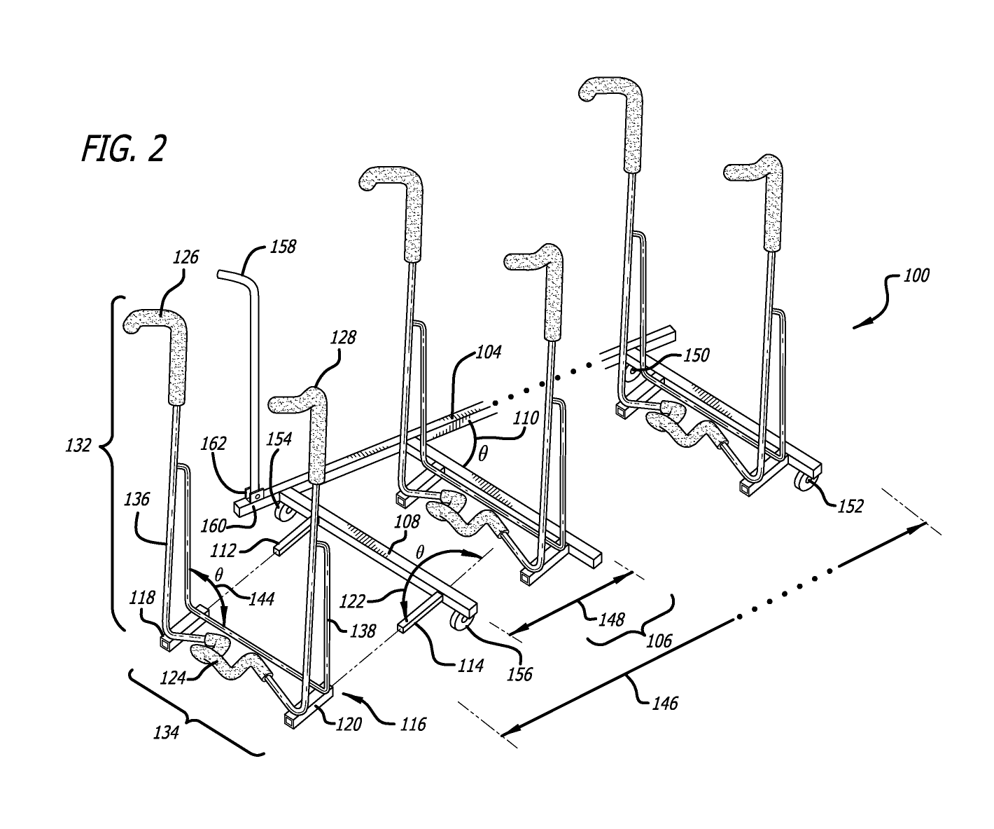

As further illustrated in FIG. 2, in addition to FIGS. 1A-G, spine 104 can include any number of bays 106 configured to each vertically support an elongated sporting board. Each bay 106 can include a support bar 108 attached to spine 104 at angle 110. Angle 110 can be any angle that can enhance sales of elongated sporting boards. For example, angle 110 can be between about 20 degrees and about 90 degrees, about 30 degrees and about 60 degrees, about 20 degrees about 45 degrees, about 20 degrees, about 25 degrees, about 30 degrees, about 35 degrees, about 40 degrees, about 45 degrees, about 50 degrees, about 55 degrees, about 60 degrees, about 65 degrees, about 70 degrees, about 75 degrees, about 80 degrees, about 85 degrees, or about 90 degrees. One skilled in the art will appreciate that in order to have the elongated sporting equipment stand vertically at an angle greater than 90 degrees, spine 104 (and accompanying support bars) only needs to be flipped over.

Support bar 108 can be configured to change angles as needed for display or portability purposes. For example, support bar 108 can have several lockable positions at different angles or can be manually tightened at a particular angle by loosening and tightening a bolt. In other embodiments, support bar 108 can be welded at a particular angle. In one embodiment, support bar can be welded at an angle of about 75 degrees.

Each support bar can be any length required to sustain weight loads of elongated sporting boards mounted on apparatus 100. For example, support bar 108 can be about 1 ft, about 2 ft, about 3 ft, about 4 ft, between about 1 ft and 2 ft, between about 1 ft and 3 ft, between about 1 ft and 4 ft, between about 2 ft and 3 ft, between about 2 ft and 4 ft, or between about 3 ft and 4 ft in length.

Further, each support bar 108 can include first attachment point 118 and second attachment point 120. In other embodiments, only one attachment point is needed. In still other embodiments, three, four, five, six, seven, or eight attachment points can be included. Attachment points can be welded, glued, or otherwise attached to support bar 108. Attachment points can be configured to engage and weld to vertical support structure 116. Further, attachment points can be spaced as needed to sustain a needed weight load on apparatus 100. For example, attachment points can be evenly spaced on a support bar or unevenly spaced on a support bar.

Each attachment point can be configured to have a complimentary shape to first vertical support assembly attachment point 118 and second vertical support assembly attachment point 120 on vertical support structure 116. The number of vertical support assembly attachment points on a given vertical support structure 116 can be that of the number of attachment points to be engaged and welded. Shapes for attachment points can have circular, rectangular, triangular, torx, oval, star, or square cross-sections. Each vertical support assembly attachment point can have a complimentary shape to its accompanying attachment point but slightly larger to allow connection between the two. In other embodiments, each vertical support assembly can be directly welded to a respective support bar.

Attachment points can be configured to attain a different angle with respect to support bar 108. In one configuration, angle 122 is 180 degrees. At 180 degrees, an elongated sporting board can stand vertically in support structure 116. However, for display purposes or if an elongated sporting board is too tall, angle 122 can be adjusted to angles smaller than 180 degrees but larger than 90 degrees. For example, angle 122 can be about 180 degrees, about 175 degrees, about 170 degrees, about 165 degrees, about 160 degrees, about 155 degrees, about 150 degrees, about 145 degrees, about 140 degrees, about 135 degrees, about 130 degrees, about 125 degrees, about 120 degrees, about 115 degrees, about 110 degrees, about 100 degrees, about 95 degrees, between about 180 degrees and about 150 degrees, between about 180 degrees and about 160 degrees, between about 180 degrees and about 170 degrees, between about 180 degrees and about 140 degrees, between about 180 degrees and about 130 degrees, or between about 180 degrees and about 120 degrees. Again, angle 122 can be adjustable as described herein or have a fixed angle.

Each vertical support structure 116 can include bottom support 124, first side support 126 and second side support 128. In the case of displaying an elongated sporting board, bottom 130 of the elongated sporting board 102 can rest on bottom support 124 while first side support 126 and second side support 128 hold the elongated sporting board in place vertically. These three support points can hold the bottom and sides of the board in place vertically. First side support 126 and second side support 128 can be elevated above first vertical support assembly attachment point 118 and second vertical support assembly attachment point 120 by sufficient height 132 to support the weight of an elongated sporting board. In some embodiments, sufficient height can be about 1 ft, about 2 ft, about 3 ft, about 4 ft, between about 1 ft and 2 ft, between about 1 ft and 3 ft, between about 1 ft and 4 ft, between about 2 ft and 3 ft, between about 2 ft and 4 ft, or between about 3 ft and 4 ft. Also, first side support 126 and second side support 128 can be at a distance 134 to support the weight of an elongated sporting board. In some embodiments, distance 134 is about 1 ft, about 2 ft, about 3 ft, about 4 ft, between about 1 ft and 2 ft, between about 1 ft and 3 ft, between about 1 ft and 4 ft, between about 2 ft and 3 ft, between about 2 ft and 4 ft, or between about 3 ft and 4 ft.

First side support 126 and second side support 128 can be elevated by first mast 136 and second mast 138 respectively. Each mast can be of any configuration that can sustain the needed weight requirement for an elongated sporting board. In one embodiment, each mast is a single straight bar configuration. In another embodiment, in order to provide more strength, each mast can have an A-frame configuration.

Portions of vertical support structure 116 that may touch or encounter an elongated sporting board or piece of equipment can include a protective coating. Portions of vertical support structure 116 can be covered with a foam-like material or a soft polymeric material that protects equipment being displayed. For example, bottom support 124, first side support 126 and second side support 128 can all include a protective coating.

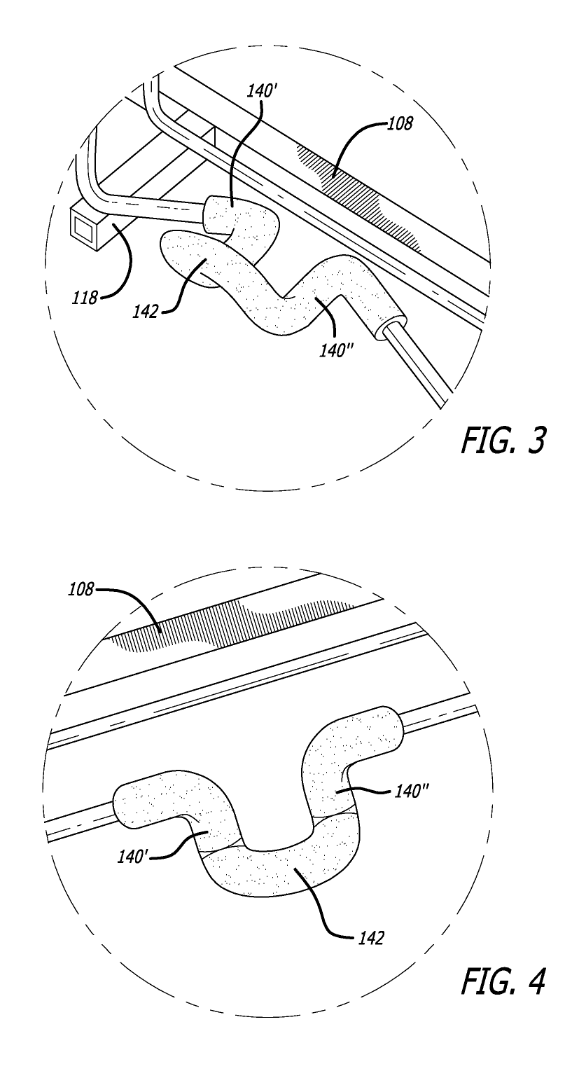

Bottom support 124 can have any shape or configuration that can accommodate the bottom of an elongated sporting board (see FIGS. 3 and 4). In one embodiment, two parallel or substantially parallel bars 140′,140″ can terminate in support lip 142 that can hold the bottom of an elongated sporting board in place. The length of parallel or substantially parallel bars 140′,140″ can vary depending on whether the elongated sporting boards are to stand up vertically or at an angle. For angled configurations, parallel or substantially parallel bars 140′,140″ can be longer allowing the bottom of an elongated sporting board to be angled away from vertical support structure 116.

First side support 126 and second side support 128 can have any shape or configuration that can accommodate the sides of an elongated sporting board. In one embodiment, first side support 126 and second side support 128 can have opposite shapes relative to one another. Each side support can have a horizontal hook shape that can at least partially contour to the side of a given elongated sporting board.

As elongated sporting boards can have different widths, distance 134 can vary depending on the width of an elongated sporting board. Differences in width can be achieved by changing the width of the base of vertical support structure 116 or simply bending first mast 136 and second mast 138 to achieve a desired angle 144. For example, angle 144 can be between about 20 degrees and about 90 degrees, about 30 degrees and about 60 degrees, about 20 degrees about 45 degrees, about 20 degrees, about 25 degrees, about 30 degrees, about 35 degrees, about 40 degrees, about 45 degrees, about 50 degrees, about 55 degrees, about 60 degrees, about 65 degrees, about 70 degrees, about 75 degrees, about 80 degrees, about 85 degrees, or about 90 degrees.

Each vertical support structure 116 can be configured to hold a total weight of at least about 2 lbs, at least about 10 lbs, at least about 35 lbs, at least about 50 lbs, at least about 100 lbs, at least about 200 lbs, at least about 300 lbs, at least about 400 lbs, about 2 lbs, about 5 lbs, about 10 lbs, about 15 lbs, about 25 lbs, about 50 lbs, about 75 lbs, about 100 lbs, about 200 lbs, about 300 lbs, about 400 lbs, about 500 lbs, about 600 lbs, between about 2 lbs and about 50 lbs, between about 2 lbs and about 25 lbs, between about 2 lbs and about 10 lbs, between about 2 lbs and about 600 lbs, or between about 5 lbs and about 10 lbs.

As described above, apparatus 100 can accommodate many different types and sizes of elongated sporting boards. Spine 104 can include a plurality of support bars. In some aspects, spine 104 can include two, three, four, five, six, seven, eight, nine, ten, eleven, twelve or more support bars 108. Each support bar 108 can be configured to accommodate a vertical support structure 116. The total length 146 of spine 104 can be important depending on the portability of apparatus 100 or even the size restrictions within a retail store bay. For example, spine 104 can be about 1 ft, about 2 ft, about 3 ft, about 4 ft, about 5 ft, about 6 ft, about 7 ft, about 8 ft, about 9 ft, about 10 ft, about 11 ft, about 12 ft, about 13 ft, about 14 ft, about 15 ft, about 16 ft, about 17 ft, about 18 ft, about 19 ft, about 20 ft, between about 1 ft and about 10 ft, between about 1 ft and about 7 ft, between about 1 ft and about 4 ft, between about 4 ft and about 7 ft, between about 2 ft and about 8 ft, between about 3 ft and about 10 ft, or between about 2 ft and about 10 ft in length.

Each support bar can be separated by distance 148. Distance 148 can be any distance that can allow proper spacing of elongated sporting equipment and proper weight distribution for apparatus 100. For example, distance 148 can be about 1 ft, about 2 ft, about 3 ft, about 4 ft, between about 1 ft and 2 ft, between about 1 ft and 3 ft, between about 1 ft and 4 ft, between about 2 ft and 3 ft, between about 2 ft and 4 ft, or between about 3 ft and 4 ft. In some embodiments, each distance 148 can be the same. In other embodiments, each distance 148 does not need to be the same.

In another embodiment, a spine may not be required. Rather, a first vertical support structure can be attached substantially perpendicular to at least two support bars which are substantially parallel to each other. First vertical support structure can be directly welded onto the at least two support bars which are substantially parallel to each other. A second vertical support structure can be directly welded onto at least one of the support bars holding first vertical support structure so that first vertical support structure and second vertical support structure share at least one support bar. In this configuration the first and second vertical support structures are in a tiered configuration.

In the above embodiment, each vertical support structure can include a bottom support, a first side support and a second side support. In the case of displaying an elongated sporting board, the elongated sporting board's bottom can rest on the bottom support while first side support and second side support hold the elongated sporting board. Additional vertical support structures can be added in the same tiered configuration. For example, a third vertical support structure can be welded by its first side support onto the support bar holding the second side support of the second vertical support structure. This way the tiered configuration remains. Further, vertical support structures can be added wherein there can be one, two, three, four, five, six, seven, eight, nine, 10, 11, 12, 13, 14, 15, 16, 17, 18, 19, 20, 21, 23, 24 or more elongated sporting boards in a tiered configuration. This configuration can be useful in assisting with selling the elongated sporting boards because for example, it can allow for easy organization by price, expertise level, brand and/or other attributes. A tiered configuration can make these attributes more appealing to the customer and also more self-explanatory if no sales person is available.

In yet another embodiment, as above there can be a first vertical support structure attached substantially perpendicular to at least two support bars which are substantially parallel to each other. First vertical support structure can be directly welded onto the at least two support bars which are substantially parallel to each other. A second vertical support structure can be directly welded onto at least one of the support bars holding the first vertical support structure so that the first vertical support structure and second vertical support structure share at least one support bar. In this configuration, the first and second vertical support structures are in a tiered configuration. Instead of continuing with the tiered configuration an additional (eg. third) vertical support structure can be welded onto the same two substantially parallel support bars as the second vertical support structure. In this particular configuration, the support bars can be any desired length to house any number of desired elongated sporting boards. For example, a support bar can be about 1 ft, about 2 ft, about 3 ft, about 4 ft, about 5 ft, about 6 ft, about 7 ft, about 8 ft, about 9 ft, about 10 ft, about 11 ft, about 12 ft, about 15 ft, about 20 ft, about 30 ft, about 40 ft, about 50 ft, between about 1 ft and 2 ft, between about 1 ft and 3 ft, between about 1 ft and 4 ft, between 1 ft and 5 ft, between 1 ft and 6 ft, between 1 ft and 7 ft, between 1 ft and 8 ft, between 1 ft and 9 ft, between 1 ft and 10 ft, between 1 ft and 11 ft, between 1 ft and 50 ft, between about 1 ft and about 6 ft, between about 2 ft and 3 ft, between about 2 ft and 4 ft, or between about 3 ft and 4 ft in length, between about 4 ft to 12 ft, between about 5 ft to 12 ft, between about 6 ft to 12 ft, between about 7 ft to 12 ft, between about 8 ft to 12, between about 9 ft to 12 ft, between about 10 ft to 12 ft, between about 11 ft to 12 ft, at least about 1 ft, at least about 2 ft, at most about 6 ft, at most about 20 ft, or at most about 30 ft. This configuration can be useful in displaying one type of elongated sporting board and then housing the rest behind one another in a linear fashion. This linear fashion can be beneficial where the boards are the same and do not need to be displayed in a tiered or other type of configuration.

In still another embodiment, a vertical support structure 116 can exist as a standalone elongated board holder. For example, a vertical support structure can be equipped with two perpendicularly oriented legs that extend from the vertical support structure enough to support a given elongated sporting board. In some embodiments, each leg can be a different length of off centered or staggered. In other embodiments, each leg can include a portion coated with a polymeric material to provide friction with the display surface. In one embodiment, polymeric material is added to the end of each leg. Further, each leg can lay flat on the ground or can be provided at an angle to raise a vertical support structure 116 off the ground.

In some embodiments, standalone elongated board holders can be joined together to provide different vertical board arrangements. For example, the back of a right leg can attach to the front of a left leg. Such an arrangement can be repeated as needed to provide a longer display apparatus. Many different arrangements can be envisioned by skilled artisans. Standalone elongated board holders can be held together using any securing arrangement. For example, securing arrangements can include any attachment or securing mechanism or apparatus described herein.

In one embodiment, apparatus 100 can be easily movable. For example, in one embodiment, apparatus 100 can include at least one wheel. For example, apparatus 100 can include first wheel 150, second wheel 152, third wheel 154, and fourth wheel 156. In other embodiments, apparatus 100 can include first wheel 150 and second wheel 152 and third wheel 154 and fourth wheel 156 can be replaced by feet. Apparatus 100 can in some embodiments include one wheel, two wheels, three wheels, four wheels, five wheels, six wheels, seven wheels, or eight wheels. In other embodiments, no wheels are included and stationary feet are included.

The wheels used can depend on the application of apparatus 100. For example for in store display purposes, four wheels, two on each base, can be used for mobility. The wheels can include locks or breaks to allow apparatus 100 to remain stationary once the wheels are locked. Also, the wheels can be retractable so that once apparatus 100 is moved to a desired location, the wheels can be retracted and the apparatus remain stationary. In one embodiment, wheels can be ball bearing wheels with built-in brakes. Alternately, if used for outdoor sporting purposes, rubber inflatable wheels can be used for ease of mobility in more rugged terrain. Further, if used for storage on beach sand, long spikes can be used that burry into the sand. Any number or kind of wheels can be used depending on the circumstances and intended use of apparatus 100.

If movable, apparatus 100 can include a handle that can aid in moving it. Handle 158 can be removable, can be permanently attached to apparatus 100, or can be movable to a storage position on apparatus 100. Handle 158 can be removably attached to apparatus 100 by any known means of attachment. In one embodiment, handle 100 can slide into or over spine 104 at end 160 and snap into place using a pin and hole combination. If handle 158 is movable to a storage position on apparatus 100, it can include hinge 162 at end 160 that can pivot handle to a position, for example, against spine 104.

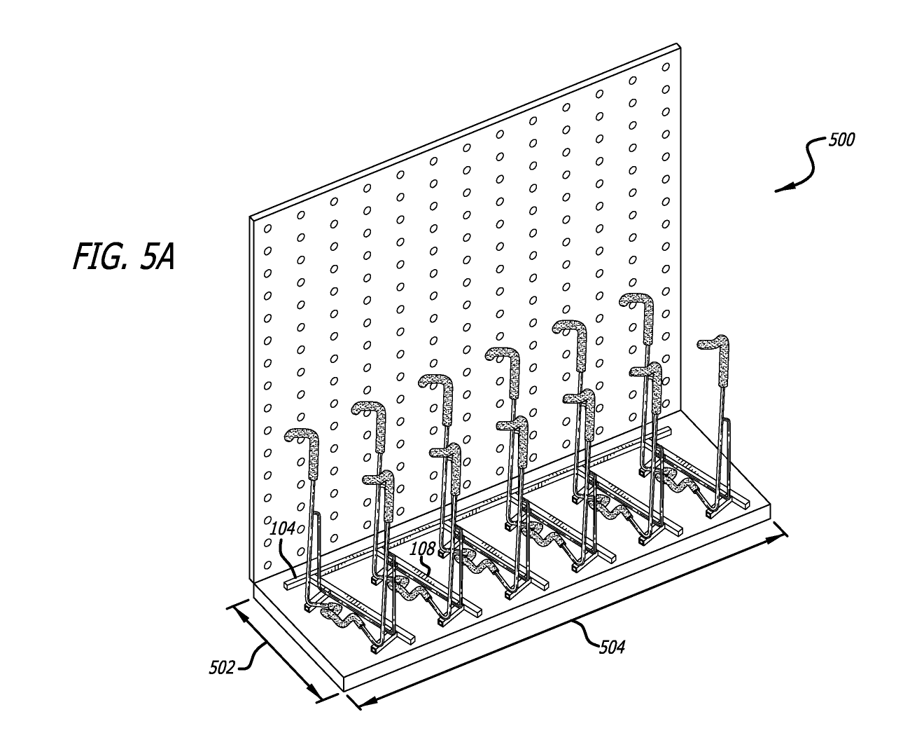

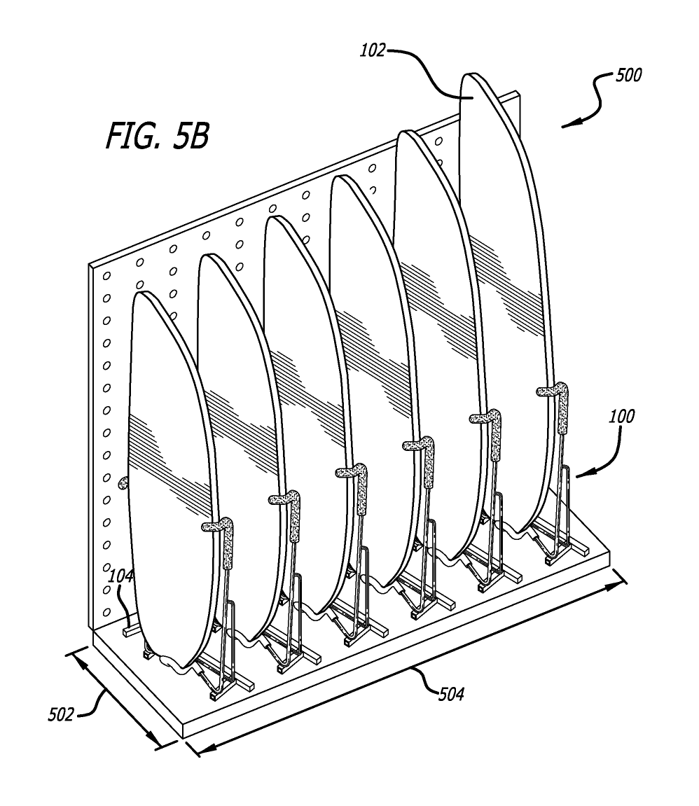

Apparatus 100 as described can have many different sizes and can be custom configured for a given situational need. In one embodiment, as illustrated in FIGS. 5A-B, the size of apparatus 100 can be based on the requirements of a given elongated sporting board retailer. The length of a support bar 108 can be dependent on depth 502 of retail space 500. Likewise, the length of spine 104 can be dependent on length 504 of retail space 500. In some embodiments, the length of spine 104 can be slightly shorter than length 504 to allow slight variations in placement of apparatus 100 within retail space 500. If space allows, more than one apparatus 100 can be lined up. In one embodiment, apparatuses can be lined up and physically mated into a line. For example, if length 504 were twice as long in FIGS. 5A-B, two apparatuses 100 could be lined up and even interlocked to add support for twice as many elongated sporting boards.

In some embodiments, apparatus 100 needs to be used in a retail space such as in FIGS. 5A-B. Rather, apparatus 100 can be positioned virtually anywhere within a retail establishment or store, at a trade show, at a sporting event (e.g., surfing competition), or the like. Apparatus 100 can be placed freestanding at the end of aisles, against walls near the sporting goods section, near the checkout line in areas where elongated sporting boards are popular (e.g., surf and paddle boards near the beach), in front of the store to attract customers, and the like. As illustrated in FIG. 5B, apparatus 100 can house six elongated sporting boards of different sizes.

Apparatus 100 can be used for storage of elongated sporting boards. Apparatus 100 can be configured to fit within a standard size 16 in, 24 in, or 26 in closet. For shallower closets, angle 110 can be decreased to decrease the depth of apparatus 100. Apparatus 100 can also be used to store elongated sporting boards in garage corridors (e.g., along the side of a parked car or along the front of a parked car), in sheds, in storage closets, and the like.

Total weight of apparatus 100 can vary depending on the particular configuration used. Hollow tubing and light weight materials can be used to form the spine and support bars to reduce the overall weight. Apparatus 100 can be light in order to aid in mobility loaded with product. In general, apparatus 100 alone can have a weight of less than about 300 lbs, less than about 200 lbs, less than about 100 lbs, less than about 50 lbs, less than about 25 lbs, or less than about 15 lbs.

In other embodiments, apparatus 100 can be disassembled. For example, vertical support structures 116 can be removed from support bars 108, and support bars 108 can be removed from spine 104. Further, spine 104 can be formed of many pieces and disassembled into multiple smaller pieces. In another embodiment, spine 104 can include a hinge or multiple hinges (not illustrated) that can allow spine 104 to collapse onto itself.

Apparatus 100 can be condensed into a space of about 2.5 ft³, about 2.6 ft³, about 2.7 ft³, about 2.8 ft³, about 2.9 ft³, about 3.0 ft³, about 3.1 ft³, about 3.2 ft³, about 3.3 ft³, about 3.4 ft³, about 3.5 ft³, about 3.6 ft³, about 3.7 ft³, about 3.8 ft³, about 3.9 ft³, about 4.0 ft³, less than about 4.0 ft³, less than about 3.5 ft³, less than about 3.2 ft³, less than about 3.0 ft³, between about 2.5 ft³ and about 4.0 ft³, between about 2.9 ft³ and about 3.1 ft³, or between about 2.5 ft³ and about 3.5 ft³. In one embodiment, when compacted, apparatus 100 can fit into a trunk of a compact car.

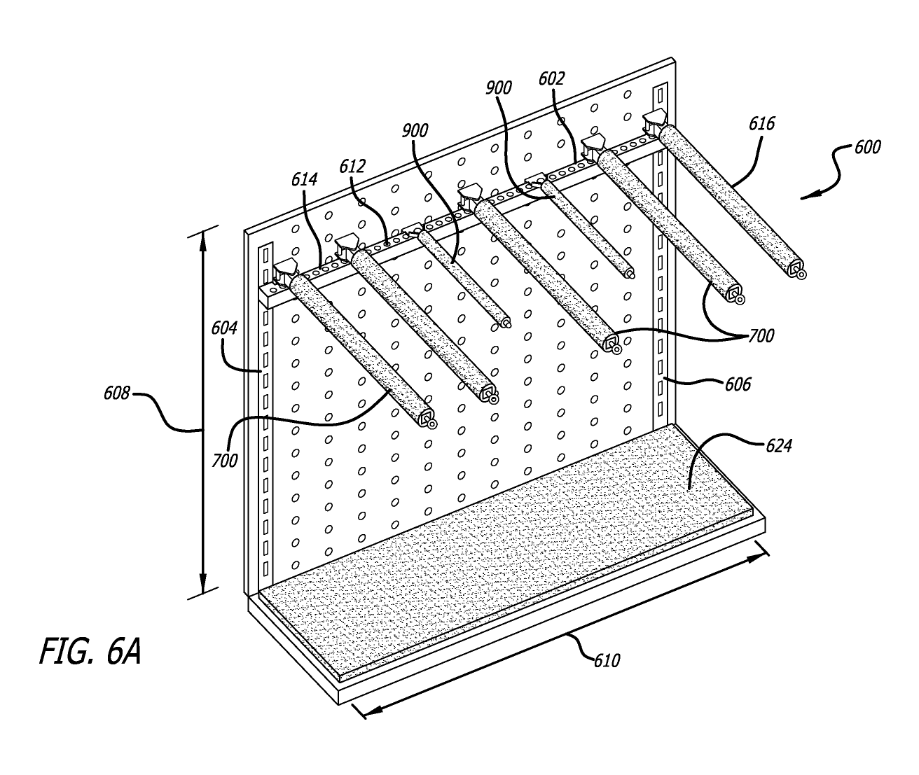

In another embodiment, elongated sporting boards can be vertically showcased using system 600 illustrated in FIGS. 6A-B. System 600 can attach or mount to standard retail aisle fixtures. For example, cross bar 602 can mount to first mounting channel 604 and second mounting channel 606. Any number of mounting channels can be accommodated by system 600.

Also, cross bar 602 is mounted at height 608, but a cross bar can be mounted at any height required by elongated sporting boards being displayed. Height 608 can again, be any height that properly supports elongated sporting boards or aids in their display and sale. Example heights can be about 1 ft, about 2 ft, about 3 ft, about 4 ft, about 5 ft, about 6 ft, about 7 ft, about 8 ft, about 9 ft, about 10 ft, between about 1 ft and about 10 ft, between about 1 ft and about 7 ft, between about 1 ft and about 4 ft, between about 4 ft and about 6 ft, between about 2 ft and about 8 ft, between about 3 ft and about 10 ft, or between about 2 ft and about 10 ft in length.

The number and distance between mounting channels can generally be determined by the particular retail location and not modifiable. However, some retail locations may allow customization of a retail space. A retail location may define a display area between two consecutive mounting channels. In some embodiments, distance 610 between two consecutive mounting channels can be about 1 ft, about 2 ft, about 3 ft, about 4 ft, about 5 ft, about 6 ft, about 7 ft, about 8 ft, about 9 ft, about 10 ft, about 11 ft, about 12 ft, between about 1 ft and about 10 ft, between about 1 ft and about 7 ft, between about 1 ft and about 4 ft, between about 4 ft and about 7 ft, between about 2 ft and about 8 ft, between about 3 ft and about 10 ft, or between about 2 ft and about 10 ft. In one embodiment, the distance is about 4 ft.

Cross bar 602 can include a plurality of holes 612 on its top face 614. Each hole in plurality of holes 612 can be evenly spaced or may not be evenly spaced. For example, the distance between two consecutive holes can be about ⅛ inch, ¼ inch, ½ inch, ¾ inch, 1 inch, 2 inches, 3 inches, 4 inches, 5 inches, 6 inches, between about ⅛ inch and about 1 inch, between about ⅛ inch and about 6 inches, between about ⅛ inch and about 2 inches, between about ¼ inch and about 1 inch, or between about ⅛ inch and about ½ inch.

Plurality of holes 612 can be used to mount at least one arm 616. Any number of arms can be used. The number of arms used can be determined by the number of elongated sporting boards to be displayed, how they are to be displayed, and the like. For example, one, two, three, four, five, six, seven, eight, nine, ten eleven, twelve, thirteen, 14, 15, 16, 17, 18, 19, 20, 21, 22, 23 or 24 arms can be used in a 4 ft span of cross bar 602.

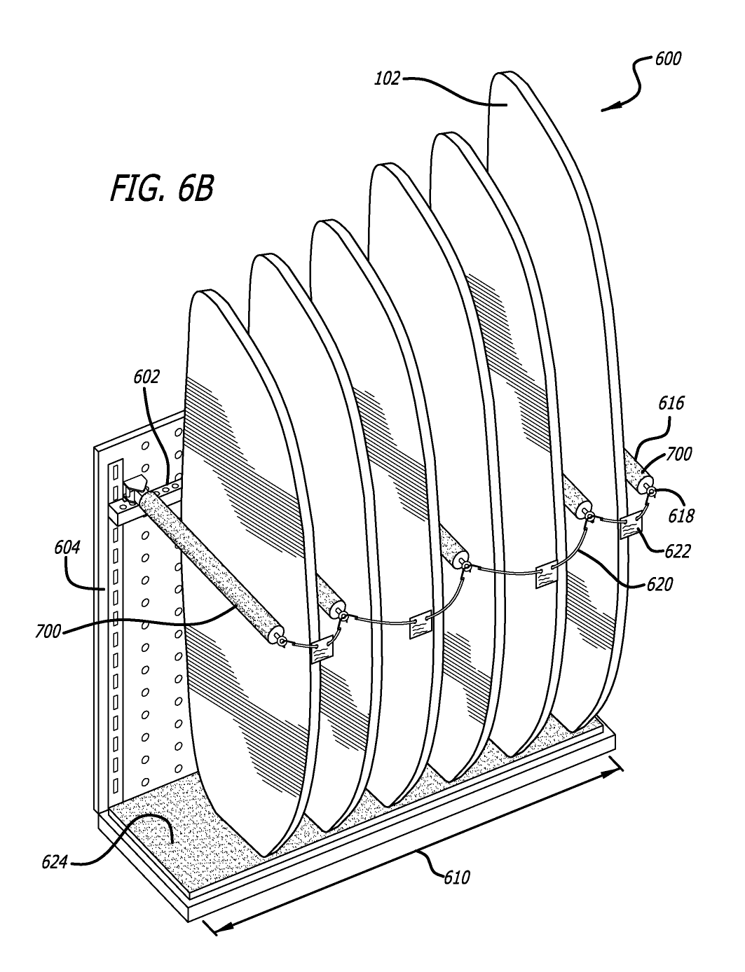

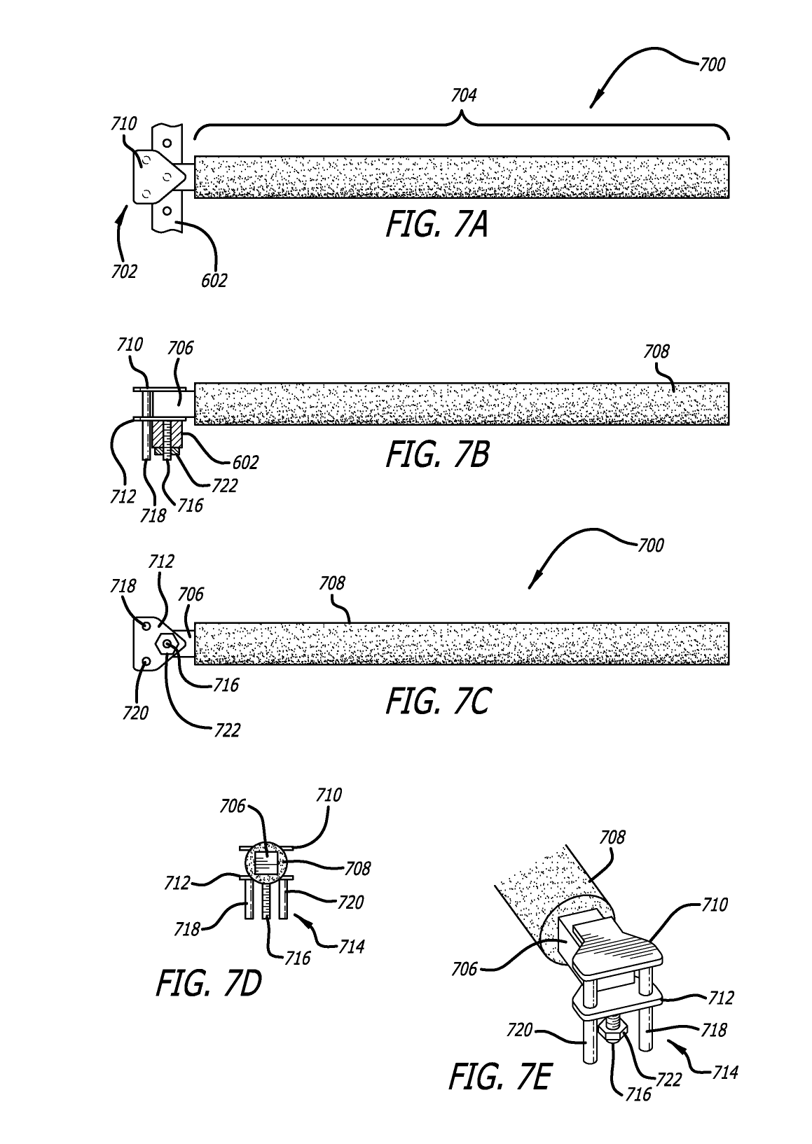

One arm that can be used with system 600 is illustrated in FIGS. 7A-E. Arm 700 includes mounting portion 702 and elongated portion 704. Mounting portion 702 can be permanently attached to elongated portion 704 or can be removably attached. Elongated portion 704 can include length of sturdy material 706. Length of sturdy material 706 can be any length that can withstand the weight of one or more elongated sporting boards. For example, length of sturdy material 706 can be about 6 in, about 1 ft, about 2 ft, about 3 ft, about 4 ft, about 5 ft, between about 6 in and about 5 ft, between about 6 in and about 3 ft, between about 6 in and about 2 ft, between about 1 ft and about 3 ft, or between about 1 ft and about 3 ft. Sturdy material can be any material that can withstand the weight loads of elongated support members once installed into system 600. Sturdy material can include, but is not limited to aluminum, copper, brass, nickel, titanium, iron, steel, stainless steel, carbon fiber, plastic, fiberglass, or a combination thereof. The metal or plastic can be solid or hollow and/or cylindrical, triangular, square, etc. in cross-section. Sturdy material can be covered or coated in a protective material 708 such as a gel, foam, plastic, etc. in order to protect elongated sporting boards to be displayed.

Turning to mounting portion 702, it can include a top plate 710 and a bottom plate 712. A plurality of pegs 714 can originate at top plate 710, traverse bottom plate 712, and protrude below bottom plate 712. Plurality of pegs 714 can include one, two, three, four, five, six, seven, or eight pegs arranged in a configuration conducive to mounting on cross bar 602. In one embodiment, mounting portion 702 can include three triangular configured pegs. In another embodiment, the triangular configuration is an equilateral triangle.

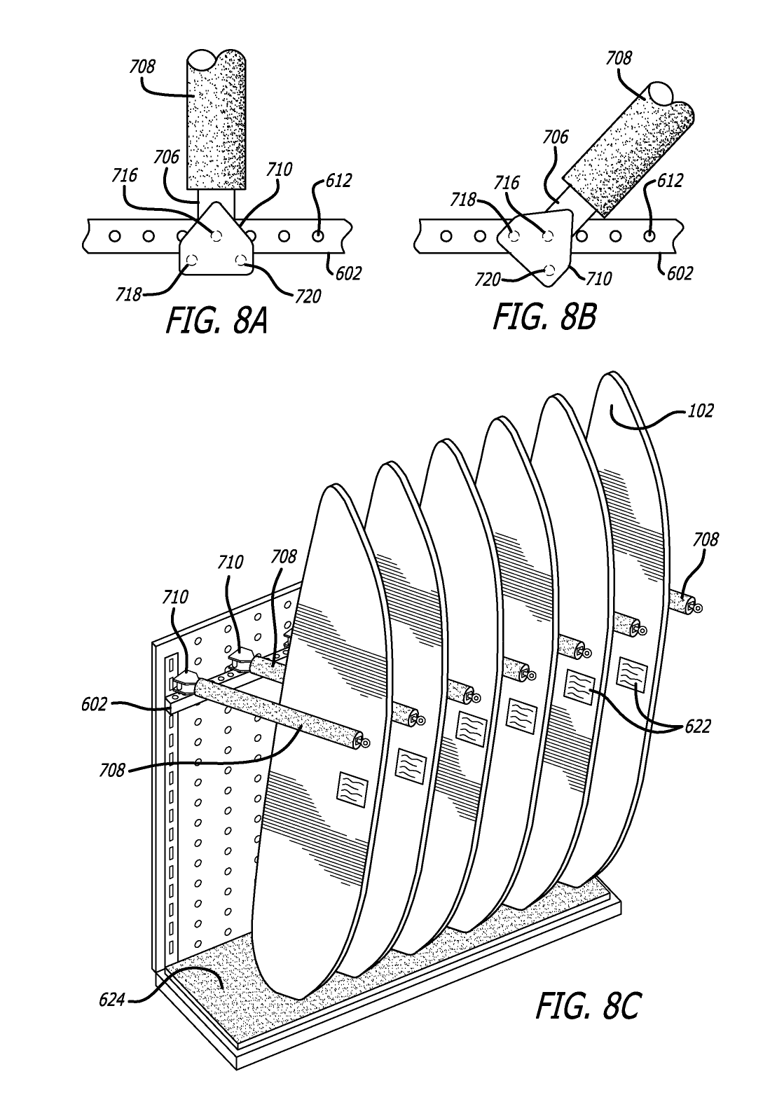

To insert arm 700 perpendicularly into cross bar 602 as illustrated in FIG. 8A, first peg 716 is inserted into a hole on cross bar 602 and second peg 718 and third peg 720 can rest against the back side of cross bar 602. In another embodiment (not illustrated), to insert arm 700 perpendicularly into cross bar 602, second peg 718 and third peg 720 are inserted into two adjacent holes on cross bar 602 and first peg 716 can rest against the front side of cross bar 602.

Bottom plate 712 can have any shape necessary to support a required load. Further, sturdy material 706 can be welded directly to the top surface or inner side surface of bottom plate 712. In one embodiment, sturdy material 706 can be welded directly to the top surface of bottom plate 712. For example, in one embodiment, no top plate 710 is required and bottom plate 712 is rectangular with wings folded down around a cross bar 602. By folding bottom plate, load can more evenly be distributed to cross bar 602. Furthermore, if bottom plate 712 folded, no pegs may be required. In other words, a folded, u-shaped bottom plate can attach to and freely slide along cross bar 602 as required in a display.

To insert arm 700 at an angle of about 135 degrees relative to cross bar 602 as illustrated in FIG. 8B, first peg 716 and second peg 718 can be inserted into adjacent holes in cross bar 602 and third peg 720 can rest against the back of cross bar 602 or freely hang without hitting cross bar 602. Alternatively, to insert arm 700 at an angle of about 45 degrees relative to cross bar 602 (e.g., opposite to FIG. 8B), first peg 716 and third peg 720 can be inserted into adjacent holes in cross bar 602 and second peg 718 can rest against the back of cross bar 602.

Each peg described herein can have a smooth surface or can be threaded. In one embodiment, a threaded peg can be long enough to traverse cross bar 602 and protrude out the bottom. When a threaded peg protrudes out the bottom of cross bar 602, nut 722 or a nut and washer can be threaded onto a peg thereby securing the arm to cross bar 602.

In other embodiments, pegs can have any shape that can complement holes in a cross bar. For example, peg cross-sections can be circular, triangular, square, torx, or the like.

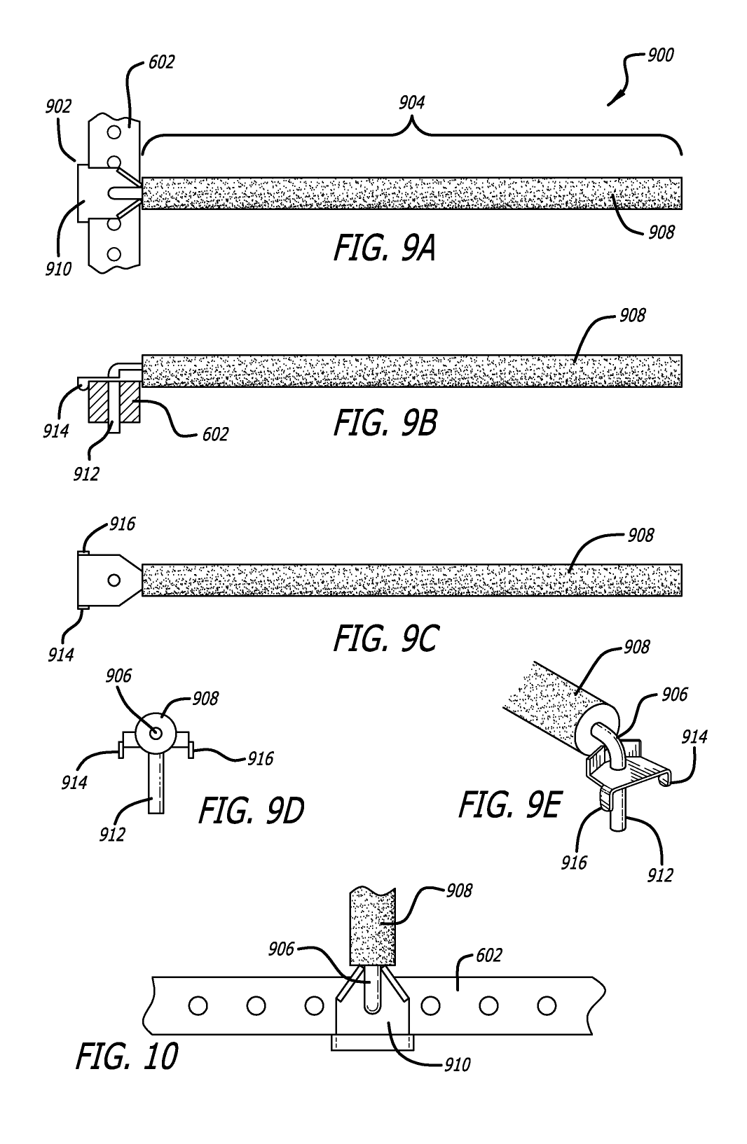

Another arm that can be used with system 600 is illustrated in FIGS. 9A-E. Arm 900 includes mounting portion 902 and elongated portion 904. Mounting portion 902 can be permanently attached to elongated portion 904 or can be removably attached. Elongated portion 904 can include length of sturdy material 906. Length of sturdy material 906 can be any length that can withstand the weight of one or more elongated sporting boards. For example, length of sturdy material 906 can be about 6 in, about 1 ft, about 2 ft, about 3 ft, about 4 ft, about 5 ft, between about 6 in and about 5 ft, between about 6 in and about 3 ft, between about 6 in and about 2 ft, between about 1 ft and about 3 ft, or between about 1 ft and about 3 ft. Sturdy material can be any material that can withstand the weight loads of elongated support members once installed into system 600. Sturdy material can include, but is not limited to aluminum, copper, brass, nickel, titanium, iron, steel, stainless steel, carbon fiber, plastic, fiberglass, or a combination thereof. The metal or plastic can be solid or hollow and/or cylindrical, triangular, square, etc. in cross-section. Sturdy material can be covered or coated in a protective material 908 such as a gel, foam, plastic, etc. in order to protect elongated sporting boards to be displayed.

Turning to mounting portion 902, it can include a top plate 910. Peg 912 can originate from sturdy material 906, bend and traverse top plate 910, and protrude below top plate 910. First support protrusion 914 and second support protrusion 916 can originate at top plate 910.

To insert arm 900 perpendicularly into cross bar 602 as illustrated in FIG. 10, peg 912 is inserted into a hole on cross bar 602 and first support protrusion 914 and second support protrusion 916 can rest against the back side of cross bar 602.

Peg 912 can have a smooth surface or can be threaded. In one embodiment, peg 912 can be long enough to traverse cross bar 602 and protrude out the bottom. When threaded, and peg 912 protrudes out the bottom of cross bar 602, a nut or a nut and washer can be threaded onto peg 912 thereby securing arm 900 to cross bar 602.

Each arm described herein can include a hook, ring, or other securing device at its terminal end. For example, as illustrated in FIG. 6A, each arm 614 can include ring 618. Ring 618 can be used for any purpose that can aid in the display or sale of elongated sporting boards. In one embodiment, ring 618 can be used to secure line 620 to at least two arms. Line 620 can be used for any purpose that can aid in the display or sale of elongated sporting boards. For example, line 620 can be used to hold elongated sporting board 102 within system 600. Line 620 can be connected to every arm, to every other arm, to every third arm, to every forth arm, to every fifth arm, to every sixth arm, to every seventh arm, to every eighth arm, to every ninth arm or to every tenth arm. In some embodiments, line 620 does not need to connect to arms in a repeatable fashion. Rather, line 620 can be attached as needed to secure a given set of elongated sporting boards 102 within system 600.

Line 620 can be made of any material. For example, line 620 can be made of string, rope, elastic rope (e.g. bungee material), chain, rubber, plastic, etc. Line 620 can further be coated to protect the displayed elongated sporting boards. Coatings can be made of a gel, foam, plastic, etc.

Line 620 can further serve as a support for printed brochures 622. Printed brochures can accompany each piece of elongated sporting equipment to assist in educating the buyer. As the buyer may not have educational help from the self service retailer, in addition to the mere display of the products themselves, printed brochures can be of help to customers.

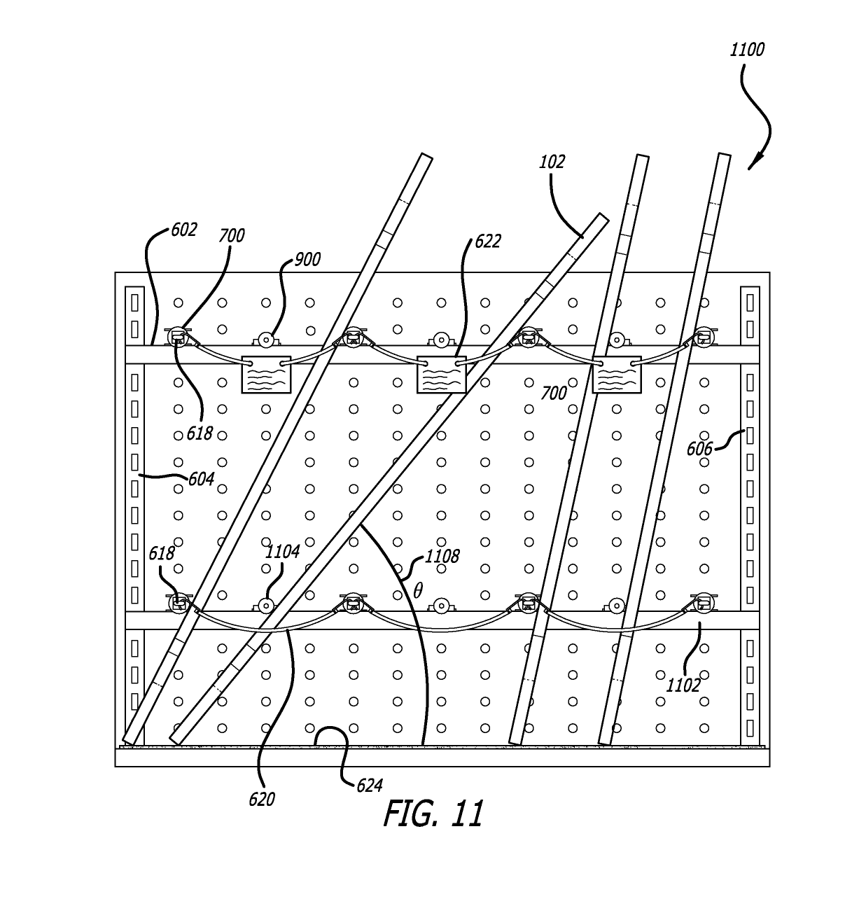

System 600 can further include bottom protector 624. Bottom protector 624 can be formed of any material that can sufficiently protect the bottoms of elongated sporting boards. For example, bottom protector 624 or mat can be formed of gel, foam, plastic, etc. Bottom protector 624 can be formed of a non-skidding surface that can prevent elongated sporting boards from moving (e.g., FIG. 11). Bottom protector 624 can also be cut into any shape that can be sufficient to protect the bottoms of elongated sporting boards. In one embodiment, bottom protector 624 covers substantially all the display base 626.

FIGS. 6B and 8C illustrate system 600 in different configurations accommodating six elongated sporting boards. One skilled in the art understands that more or fewer boards can be accommodated by different system configurations. For example, less space can be provided between adjacent arms thereby allowing more arms and in turn more boards in a given area.

In some embodiments, elongated sporting boards may be too tall to display completely vertically. For example, a 12 ft board cannot stand up vertically in a retail location with a 10 ft ceiling. As such, in some embodiments, system 600 can be supplemented to allow elongated sporting boards to stand at an angle. Such a system can be as illustrated in FIG. 11 as system 1100.

In addition to cross bar 602 and arms 616 from system 600, system 1100 further includes second cross beam 1102 and first bottom arm 1104. Optionally, a second bottom arm can be included. The number of arms used can be determined by the number of elongated sporting boards to be displayed, how they are to be displayed, and the like. For example, one, two, three, four, five, six, seven, eight, nine, ten eleven, twelve, thirteen, 14, 15, 16, 17, 18, 19, 20, 21, 22, 23 or 24 arms can be used in a 4 ft span of a cross bar such as cross bar 602. Elongated sporting board 102 can be configured to rest at angle 1108 and against first bottom arm 1104. Angle 1108 can be any angle that allows elongated sporting board 102 to clear the ceiling height. For example, angle 1108 can be about 89 degrees, about 88 degrees, about 87 degrees, about 86 degrees, about 85 degrees, about 84 degrees, about 83 degrees, about 82 degrees, about 81 degrees, about 80 degrees, about 79 degrees, about 78 degrees, about 77 degrees, about 76 degrees, about 75 degrees, about 70 degrees, about 65 degrees, about 60 degrees, about 55 degrees, about 50 degrees, about 45 degrees, between about 89 degrees and about 70 degrees, between about 89 degrees and about 80 degrees, between about 89 degrees and about 75 degrees, between about 85 degrees and about 70 degrees, between about 85 degrees and about 75 degrees, or between about 89 degrees and about 45 degrees. Angle 1108 can be varied by moving first bottom arm 1104 left and right to attain the proper angle.

Also described herein are methods of selling elongated sporting equipment in a self service retailer. A self service retailer is a retail or warehouse location where a potential buyer of products has minimal or less than minimal input from any employees at the self service retailer. In such stores, a buyer may not even seek an employee for checkout; rather, the buyer may perform a self checkout using an in-store self checkout machine or a smartphone or tablet application. In some embodiments, a buyer has no interaction or input at all from any employees. Example self service retailers include, but are not limited to, military post exchange stores (“PX stores”), warehouse retailers (e.g., Costco), liquidation stores, and the like.

In such, self service retailers, since the buyer has minimal to less than minimal contact with employees or even minimal or less than minimal interaction with employees that have knowledge of the products being sold, the products must in some cases sell themselves. As such, the present apparatus, e.g., apparatus 100 or system 600, can present at least one elongated sporting board in a display orientation so the buyer can properly visualize the products being sold.

In one embodiment, an apparatus or system described herein can be used to display to a buyer one or more elongated sporting boards. One or more vertical display orientations can aid a buyer in seeing the equipment at different angles and at different lighting conditions. Additionally, the vertical display orientations can allow the display of different color equipment or differently configured equipment for the self education of the buyer.

The minimalist design of apparatus 100 can aid in the education to the buyer of the light weight of the elongated sporting equipment. A buyer can be further assured that the sporting equipment is relatively light when resting on or in the present display apparatus and systems.

Further, printed brochures can accompany each piece of elongated sporting equipment to assist in educating the buyer. As the buyer may not have educational help from the self service retailer, in addition to the mere display of the products themselves, printed brochures can be attached to an apparatus spine or an elongated sporting board itself. Printed brochures as described herein can be of any size that aids in the education and sale of the product. The size can be about 3×5 in, about 8.5×11 in, or the like. Bold colors and fonts can be used on or for the printed brochures. The printed brochure can include information about the product's price, weight, dimensions, use explanation, performance characteristics, preferred age range, precautions, use instructions, recommendations, recommended accessories, recommended upgrades, comparisons to competitor products, company profile, company history, explanation of company's role in the community, company's military affiliations, company's affiliation with charitable organizations, product awards, product reviews, critics' reviews, user reviews, other product colors, photos of product, photos of product in use, warranty information, warranty disclaimer, nature, building materials, recommended upkeep instructions, and the like.

Methods of selling elongated sporting boards in a self service retailer are described. The methods include mounting at least one elongated sporting board on a self selling display spine or in a display apparatus. The self selling display spine can include at least one vertical support assembly to display an elongated sporting board in a vertical orientation. Once elongated sporting boards are placed on the self selling display, the display can be rolled to a desired store location. In other embodiments, the self selling display can be assembled at a particular store location and then loaded with elongated sporting boards. As described herein, minimal or less than minimal input from the self service retailer about the elongated sporting board may be provided, requiring a buyer to self educate him/herself about the elongated sporting board. The methods can sell the at least one elongated sporting board to the buyer.

Use of the apparatus described herein to sell elongated sporting boards can increase sales by at least about 2%, at least about 4%, at least about 6%, at least about 8%, at least about 10%, at least about 15%, at least about 20%, at least about 25%, at least about 30%, at least about 40%, at least about 50%, about 2%, about 4%, about 6%, about 8%, about 10%, about 15%, about 20%, about 25%, about 30%, about 40%, about 50%, between about 2% and about 50%, between about 2% and about 25%, between about 2% and about 15%, between about 2% and about 10%, or between about 10% and about 40% annually.

### Example 1

### Portable Vertical Display Apparatus

A display having a spine with six support bars is laid out. Six vertical support structures as described are attached to attachment points associated with each support bar. Once assembled, the apparatus can be moved to a desired location within a self service retailer. Then six elongated sporting boards can be loaded into the apparatus, one in each vertical support structure and displayed for sale.

### Example 2

### Stationary Vertical Display Apparatus

A four foot wide retail store display shelf area is assigned to a seller of elongated sporting boards. A cross bar is attached to at least two vertical mounting channels. Thirteen arms are attached perpendicular to the cross bar and bolted into place using a nut attached to at least one threaded peg on each arm. Twelve elongated sporting boards are vertically slotted into spaces between two consecutive arms. A line is attached to at least some of the arms to keep the elongated sporting boards from falling out of the display.

### Example 3

### Another Stationary Vertical Display Apparatus

A four foot wide retail store display shelf area is assigned to a seller of elongated sporting boards. A cross bar is attached to at least two vertical mounting channels. Four arms are attached at 45 degree angles relative to the cross bar and bolted into place using a nut attached to at least one threaded peg on each arm. Three elongated sporting boards are vertically slotted into spaces between two consecutive arms. A line is attached to each of the arms to keep the elongated sporting boards from falling out of the display.

### Example 4

### Selling an Elongated Sporting Board

At least one elongated sporting board is vertically mounted to a display as described. A pamphlet is associated with each board. A customer enters the self service retailer where employees have little or no knowledge of the products being sold. The customer is lured to an elongated sporting board by its display, he reads the pamphlet and understands the characteristics of the board, and without help from the self service retailer buys the elongated sporting board.

Unless otherwise indicated, all numbers expressing quantities of ingredients, properties such as molecular weight, reaction conditions, and so forth used in the specification and claims are to be understood as being modified in all instances by the term “about.” Accordingly, unless indicated to the contrary, the numerical parameters set forth in the specification and attached claims are approximations that may vary depending upon the desired properties sought to be obtained by the present invention. At the very least, and not as an attempt to limit the application of the doctrine of equivalents to the scope of the claims, each numerical parameter should at least be construed in light of the number of reported significant digits and by applying ordinary rounding techniques. Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in their respective testing measurements.

The terms “a,” “an,” “the” and similar referents used in the context of describing the invention (especially in the context of the following claims) are to be construed to cover both the singular and the plural, unless otherwise indicated herein or clearly contradicted by context. Recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein is intended merely to better illuminate the invention and does not pose a limitation on the scope of the invention otherwise claimed. No language in the specification should be construed as indicating any non-claimed element essential to the practice of the invention.

Groupings of alternative elements or embodiments of the invention disclosed herein are not to be construed as limitations. Each group member may be referred to and claimed individually or in any combination with other members of the group or other elements found herein. It is anticipated that one or more members of a group may be included in, or deleted from, a group for reasons of convenience and/or patentability. When any such inclusion or deletion occurs, the specification is deemed to contain the group as modified thus fulfilling the written description of all Markush groups used in the appended claims.

Certain embodiments of this invention are described herein, including the best mode known to the inventors for carrying out the invention. Of course, variations on these described embodiments will become apparent to those of ordinary skill in the art upon reading the foregoing description. The inventor expects skilled artisans to employ such variations as appropriate, and the inventors intend for the invention to be practiced otherwise than specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

In closing, it is to be understood that the embodiments of the invention disclosed herein are illustrative of the principles of the present invention. Other modifications that may be employed are within the scope of the invention. Thus, by way of example, but not of limitation, alternative configurations of the present invention may be utilized in accordance with the teachings herein. Accordingly, the present invention is not limited to that precisely as shown and described.

I claim:

1. An elongated sporting board rack system comprising:
a spine including at least a first vertical support structure and a second vertical support structure each configured to vertically support at least one elongated sporting board at a presentation angle.

2. The elongated sporting board rack system of claim 1, wherein the spine includes at least a first support bar configured to mount the first vertical support structure and a second support bar configured to mount the second vertical support structure.

3. The elongated sporting board rack system of claim 2, wherein the first support bar and the second support bar are oriented at an angle of about 105 degrees relative to the spine.

4. The elongated sporting board rack system of claim 1, wherein the first vertical support structure and a second vertical support structure include a bottom support, a first side support, and a second side support.

5. The elongated sporting board rack system of claim 4, wherein the bottom support is configured to support the bottom of an elongated sporting board, the first side support is configured to support a first side of the elongated sporting board and the second side support is configured to support a second side of the elongated sporting board.

6. The elongated sporting board rack system of claim 1, wherein the elongated sporting board is a surfboard, a paddle board, a boogie board, a wake board, a knee board, a skim board, a snowboard, a skateboard, a roller board, a sled, or a combination thereof.

7. The elongated sporting board rack system of claim 1, further comprising at least two support bars wherein the at least first vertical support structure is attached substantially perpendicular to the at least two support bars which are substantially parallel to each other and the at least second vertical support structure is attached to at least one of the support bars holding the at least first vertical support structure wherein the at least first vertical support structure and at least second vertical support structure share at least one support bar in a tiered configuration and wherein the spine is not required.

8. An elongated sporting board rack system comprising:
a cross bar configured to mount on at least two vertical tracks; and
a first arm covered in a protective material; and
a second arm covered in a protective material,
wherein the first arm and the second arm are configured to mount on the cross bar and to vertically support an elongated sporting board at a presentation angle.

9. The elongated sporting board rack system of claim 8, wherein the first arm and the second arm are oriented between about 45 degrees to about 90 degrees relative to the cross bar.

10. The elongated sporting board rack system of claim 8, wherein the elongated sporting board rests between the first arm and the second arm.

11. The elongated sporting board rack system of claim 8, further comprising
a second cross bar configured to mount lower than the first cross bar;
a third arm covered in a protective material; and
a fourth arm covered in a protective material,
wherein the third arm and the fourth arm are configured to mount on the second cross bar at a location offset from the first arm and the second arm thereby allowing the elongated sporting board to rest at an angle of at least 45 degrees relative to the ground.

12. The elongated sporting board rack system of claim 8, wherein the elongated sporting board is a surfboard, a paddle board, a boogie board, a wake board, a knee board, a skim board, a snowboard, a skateboard, a roller board, a sled, or a combination thereof.

13. A method of selling an elongated sporting board in a self service retailer comprising:
displaying to a buyer the elongated sporting board on a self selling display apparatus configured to vertically support at least one elongated sporting board at a presentation angle; and
selling the at least one elongated sporting board to the buyer with minimal or less than minimal input from the self service retailer.

14. The method of claim 13, wherein the self service retailer is a warehouse or a military exchange.

15. The method of claim 13, further comprising:
placing the self selling display apparatus at a location of interest; and
loading an elongated sporting board into each of six vertical support structures.

16. The method of claim 13, wherein the self selling display apparatus comprises a cross bar configured to mount on at least two vertical tracks; first arm covered in a protective material; and a second arm covered in a protective material, wherein the first arm and the second arm are configured to mount on the cross bar and to vertically support an elongated sporting board.

17. The method of claim 16, wherein the first arm and the second arm are oriented about 45 degrees to about 90 degrees relative to the cross bar.

18. The method of claim 16, wherein the elongated sporting board rests between the first arm and the second arm.

19. The method of claim 16, wherein the self selling display apparatus further comprises
a second cross bar configured to mount lower than the first cross bar;
a third arm covered in a protective material; and
a fourth arm covered in a protective material,
wherein the third arm and the fourth arm are configured to mount on the second cross bar at a location offset from the first arm and the second arm thereby allowing the elongated sporting board to rest at an angle of at least 45 degrees relative to the ground.

20. The method of claim 16, wherein the elongated sporting board is a surfboard, a paddle board, a boogie board, a wake board, a knee board, a skim board, a snowboard, a skateboard, a roller board, a sled, or a combination thereof.
